(19) United States
(12) Patent Application Publication
(10) Pub. No.: US 2017/0193702 A1
(43) Pub. Date: Jul. 6, 2017

(54) HEAD-MOUNTED DISPLAY DEVICE AND METHOD FOR INTERACTION BETWEEN HEAD-MOUNTED DISPLAY DEVICE AND INTELLIGENT TERMINAL

(71) Applicant: Beijing Pico Technology Co., Ltd., HaiDian District (CN)

(72) Inventor: Wei Li, Hai Dian District (CN)

(21) Appl. No.: 15/213,040

(22) Filed: Jul. 18, 2016

(30) Foreign Application Priority Data
Dec. 31, 2015 (CN) 201511032588.X

(51) Int. Cl. G06T 19/00; G02B 27/01; H04W 4/00

(52) U.S. Cl. CPC G06T 19/006; H04W 4/008; G02B 27/0172; G02B 2027/014

(57) ABSTRACT

The technical solution provided by the present invention by means of adding an interaction module on the head-mounted display device, collects interaction information to be input from the user to the virtual reality scene, processes the interaction information, and transmits processing result to the intelligent terminal in corresponding protocol for processing by a virtual reality scene application program of the intelligent terminal, thereby achieving the purpose of interacting with the virtual reality scene through the head-mounted display device without any third party device, and improving the portability. Multiple interaction devices are mounted on the head-mounted display device, and interaction information thereof is transferred to the intelligent terminal through the head-mounted display device. The intelligent terminal is only connected to the head-mounted display device, thereby decreasing the load of the intelligent terminal, and improving the universality of the head-mounted display device, so that the head-mounted display device can be easily extended.

### CROSS-REFERENCE TO RELATED APPLICATIONS

This application claims priority to Chinese Application Number 201511032588.X filed Dec. 31, 2015, which is incorporated herein by reference in its entirety.

### TECHNICAL FIELD

The present invention relates to the technical field of visual devices, and particularly, to a head-mounted display device and a method for interaction between the head-mounted display device and an intelligent terminal.

### BACKGROUND

The Head-Mounted Display (HMD) is a completely new technique in the modern display techniques, and it has important applications in the aspects such as enhancement displaying, virtual realization and stereo displaying. In recent years, with the gradual maturity of the virtual reality technique, various hardware and software products related to virtual realities appear successively, wherein the HMD device is widely used in coordination to simulate and realize the virtual reality environment. But currently, the main function of the HMD device in the market is still to process optical images, which is relatively single. When employing a virtual reality system, the user can experience the image of the virtual reality environment, but experiences in other aspects besides the visual sense cannot be obtained. Particularly in the interaction with the virtual reality, there is no good solution in the market, and in many situations, a simulation is made through an additional connection to other device (e.g., handle, keyboard, and third party external device).

### SUMMARY

Various embodiments of a head-mounted display device and various embodiments of a method for interaction between a head-mounted display device and an intelligent terminal are disclosed herein.

In a first non-limiting embodiment, the head-mounted display device includes, but is not limited to, an interaction module, a control module and a data transmitting module. The control module is connected to the interaction module and the data transmitting module, respectively. The head-mounted display device establishes a communication connection with an intelligent terminal through the data transmitting module, and the intelligent terminal is installed with an application program which constructs a virtual reality scene. The interaction module is configured to collect interaction information transmitted to the virtual reality scene on the intelligent terminal, and transmit the collected interaction information to the control module. The control module is configured to, after receiving the interaction information collected by the interaction module, process the interaction information into interaction data and transmits the interaction data to the data transmitting module. The data transmitting module is configured to, after receiving the interaction data transmitted from the control module, transmit the interaction data to the intelligent terminal in corresponding data communication protocol, and the intelligent terminal parses corresponding interaction information according to the interaction data and transfers the parsed interaction information to the virtual reality scene thereon.

In another non-limiting embodiment, the method for interaction between a head-mounted display device and an intelligent terminal is disclosed. The head-mounted display device is provided with an interaction module, a control module and a data transmitting module, wherein the head-mounted display device establishes a communication connection with the intelligent terminal through the data transmitting module, and wherein the intelligent terminal is installed with an application program which constructs a virtual reality scene. The method includes, but is not limited to, collecting, by the head-mounted display device through the interaction module thereon, interaction information transmitted to the virtual reality scene on the intelligent terminal. The method further includes, but is not limited to, processing, by the head-mounted display device through the control module thereon, the interaction information into interaction data, and through the data transmitting module thereon, transmitting the interaction data to the intelligent terminal in corresponding data communication protocol. The method still further includes, but is not limited to, parsing, by the intelligent terminal, corresponding interaction information according to the interaction data and transferring the parsed interaction information to the virtual reality scene thereon.

In view of the above problem that the HMD device has a single function, and lacks a function of interacting with the virtual reality system, the present invention provides a head-mounted display device and a method for interaction between the head-mounted display device and an intelligent terminal, so as to solve or at least partially solve the above problem.

According to one aspect of the present invention, a head-mounted display device is provided, wherein the head-mounted display device is provided with an interaction module, a control module and a data transmitting module; the control module is connected to the interaction module and the data transmitting module, respectively; the head-mounted display device establishes a communication connection with an intelligent terminal through the data transmitting module, and the intelligent terminal is installed with an application program which constructs a virtual reality scene;

the interaction module is configured to collect interaction information transmitted to the virtual reality scene on the intelligent terminal, and transmit the collected interaction information to the control module;

the control module is configured to, after receiving the interaction information collected by the interaction module, process the interaction information into interaction data and transmits the interaction data to the data transmitting module;

the data transmitting module is configured to, after receiving the interaction data transmitted from the control module, transmit the interaction data to the intelligent terminal in corresponding data communication protocol, and the intelligent terminal parses corresponding interaction information according to the interaction data and transfers the parsed interaction information to the virtual reality scene thereon.

Optionally, the interaction information collected by the interaction module comprises defined interaction information and undefined interaction information;

the defined interaction information is processed into interaction data by the control module according to a standard protocol format; and the undefined interaction information is processed into interaction data of a uniform rule by the control module according to a self-defined protocol format.

Optionally, one or more connection modes are established between the data transmitting module and the intelligent terminal;

the control module monitors the connection modes between the data transmitting module and the intelligent terminal in real time, and according to the processed interaction data, controls the data transmitting module to transmit the interaction data using one of the connection modes.

Optionally, the connection modes established between the data transmitting module and the intelligent terminal include a wired USB connection and/or a wireless BLUETOOTH® connection, wherein the wireless BLUETOOTH® connection comprises a connection using a HID protocol and/or a connection using an SPP protocol;

when the data transmitting module and the intelligent terminal are in a wired USB connection, the control module controls the data transmitting module to transmit data in the wired USB connection mode; and

when the data transmitting module and the intelligent terminal are in a wireless BLUETOOTH® connection, the control module controls the data transmitting module to transmit the interaction data in the HID protocol if the interaction data is of single data bit, and the control module controls the data transmitting module to transmit the interaction data in the SPP protocol if the interaction data is of multiple data bits.

Optionally, the interaction module comprises one or more of a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor.

According to another aspect of the present invention, a method for interaction between a head-mounted display device and an intelligent terminal is provided, wherein the head-mounted display device is provided with an interaction module, a control module and a data transmitting module; the head-mounted display device establishes a communication connection with the intelligent terminal through the data transmitting module, and the intelligent terminal is installed with an application program which constructs a virtual reality scene; the method comprises:

collecting, by the head-mounted display device through the interaction module thereon, interaction information transmitted to the virtual reality scene on the intelligent terminal;

processing, by the head-mounted display device through the control module thereon, the interaction information into interaction data, and through the data transmitting module thereon, transmitting the interaction data to the intelligent terminal in corresponding data communication protocol; and

parsing, by the intelligent terminal, corresponding interaction information according to the interaction data and transferring the parsed interaction information to the virtual reality scene thereon.

Optionally, the interaction information collected by the interaction module comprises defined interaction information and undefined interaction information;

the defined interaction information is processed into interaction data by the head-mounted display device through the control module according to a standard protocol format; and the undefined interaction information is processed into interaction data of a uniform rule by the head-mounted display device through the control module according to a self-defined protocol format.

Optionally, the head-mounted display device establishes one or more connection modes with the intelligent terminal through the data transmitting module;

the head-mounted display device monitors the connection modes between the data transmitting module and the intelligent terminal in real time through the control module, and according to the processed interaction data, controls the data transmitting module to transmit the interaction data using one of the connection modes.

Optionally, the connection modes with the intelligent terminal established by the head-mounted display device through the data transmitting module include a wired USB connection and/or a wireless BLUETOOTH® connection, wherein the wireless BLUETOOTH® connection comprises a connection using a HID protocol and/or a connection using an SPP protocol;

when the head-mounted display device is in a wired USB connection with the intelligent terminal through the data transmitting module, the head-mounted display device controls the data transmitting module through the control module to transmit data in the wired USB connection mode;

when the head-mounted display device is in a wireless BLUETOOTH® connection with the intelligent terminal through the data transmitting module, the head-mounted display device controls the data transmitting module through the control module to transmit the interaction data in the HID protocol if the interaction data is of single data bit, and controls the data transmitting module through the control module to transmit the interaction data in the SPP protocol if the interaction data is of multiple data bits.

Optionally, the interaction module comprises one or more of a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor.

It can be seen that the technical solution provided by the present invention by means of adding an interaction module on the head-mounted display device, collects interaction information to be input from the user to the virtual reality scene, processes the interaction information, and transmits processing result to the intelligent terminal in corresponding protocol for being processed by a virtual reality scene application program of the intelligent terminal, thereby achieving the purpose of interacting with the virtual reality scene through the head-mounted display device without any third party device, and improving the portability. Multiple interaction devices are mounted on the head-mounted display device, and interaction information thereof is transferred to the intelligent terminal through the head-mounted display device. The intelligent terminal is only connected to the head-mounted display device, thereby decreasing the load of the intelligent terminal, and improving the universality of the head-mounted display device, so that the head-mounted display device can be easily extended.

The above descriptions just summarize the technical solutions of the present invention, which can be embodied based on the content of the Description so as to understand the technical means of the present invention more clearly. Furthermore, in order to enable the above and other objects, features and advantages of the present invention to be understood more obviously and easily, the embodiments of the present invention are specifically given as follows.

### BRIEF DESCRIPTION OF THE DRAWINGS

The present invention will hereinafter be described in conjunction with the following drawing figures, wherein like numerals denote like elements, and the same part is denoted with the same reference signs throughout the drawings. In which,

FIG. 1 is a schematic diagram illustrating a head-mounted display device according to a non-limiting embodiment of the present invention;

FIG. 2 is a schematic diagram illustrating a non-limiting embodiment of a method for interaction between a head-mounted display device and an intelligent terminal according to an embodiment of the present invention;

FIG. 3 is a flow diagram illustrating a non-limiting embodiment of a method for interaction between a head-mounted display device and an intelligent terminal according to an embodiment of the present invention.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The exemplary embodiments of the present disclosure will be described more detailed with reference to the drawings. Although the drawings illustrate the exemplary embodiments of the present disclosure, it shall be appreciated that the present disclosure can be implemented in various ways, rather than being restricted by the embodiments elaborated herein. On the contrary, those embodiments are provided for understanding the present disclosure more thoroughly, and communicating the range of the present disclosure to those skilled in the art completely. In order that the objects, technical solutions and advantages of the present invention are clearer, the embodiments of the present invention will be further described in details with reference to the drawings.

In order that the objects, technical solutions and advantages of the present invention are clearer, the embodiments of the present invention will be further described in details with reference to the drawings.

FIG. 1 is a schematic diagram illustrating a head-mounted display device according to a non-limiting embodiment of the present invention. As illustrated in FIG. 1, the head-mounted display device 100 is provided with an interaction module 110, a control module 120, and a data transmitting module 130, wherein the control module 120 is connected to the interaction module 110 and the data transmitting module 130, respectively; the head-mounted display device establishes a communication connection with an intelligent terminal through the data transmitting module 130, and the intelligent terminal is installed with an application program which constructs a virtual reality scene.

The interaction module 110 is configured to collect interaction information transmitted to the virtual reality scene on the intelligent terminal, and transmit the collected interaction information to the control module 120.

After receiving the interaction information collected by the interaction module 110, the control module 120 processes the interaction information into interaction data and transmits the interaction data to the data transmitting module 130.

After receiving the interaction data transmitted from the control module 120, the data transmitting module 130 transmits the interaction data to the intelligent terminal in corresponding data communication protocol, and the intelligent terminal parses corresponding interaction information according to the interaction data and transfers the parsed interaction information to the virtual reality scene thereon.

The technical solution provided by the present invention by means of adding an interaction module on the head-mounted display device, collects interaction information to be input from the user to the virtual reality scene, processes the interaction information, and transmits processing result to the intelligent terminal in corresponding protocol for being processed by an application program of the intelligent terminal, thereby achieving the purpose of interacting with the virtual reality scene through the head-mounted display device without any third party device, and improving the portability. As to undefined interaction information, it is processed into interaction data of a uniform rule by a control module on the head-mounted display device according to a self-defined protocol format. Multiple interaction devices are mounted on the head-mounted display device, and interaction information thereof is transferred to the intelligent terminal through the head-mounted display device. The intelligent terminal is only connected to one device, i.e., the head-mounted display device, thereby decreasing the load of the intelligent terminal, and improving the universality of the head-mounted display device, so that the head-mounted display device can be easily extended.

In one embodiment of the present invention, the interaction module 110 comprises various devices meeting the operation habit of the virtual reality system and facilitating the user's usage, including one or more devices selected from a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor. In practical applications, the interaction module 110 may be, but not limited to, an input module or a sensor module of the virtual reality device. The above description is just a specific embodiment, rather than a limitation to the claims of the present invention.

In one embodiment of the present invention, the interaction information collected by the interaction module 110 comprises defined interaction information and undefined interaction information. The defined interaction information is processed into interaction data by the control module 120 according to a standard protocol format. For example, audio data may be transmitted using an A2DP protocol, or the conversation such as answering and hang-up of the intelligent terminal may be controlled through an HFP protocol.

The undefined interaction information is processed into interaction data of a uniform rule by the control module 120 according to a self-defined protocol format. Since various external devices on the HMD device, such as some sensors, are different from each other, interaction information thereof is not defined. In order for a communication with a cellular phone, device communications of the HMD and the cellular phone need to be unified as consistent with each other, i.e., the interaction information is processed into interaction data of a uniform rule, wherein device model, type, act bit, data bit, check bit, etc. are marked in the self-defined data protocol.

In one embodiment of the present invention, one or more connection modes are established between the data transmitting module 130 and the intelligent terminal. The control module 120 monitors the connection modes between the data transmitting module 130 and the intelligent terminal in real time, and according to the processed interaction data, controls the data transmitting module 130 to transmit the interaction data using one of the connection modes.

In the above embodiments, the connection modes established between the data transmitting module 130 and the intelligent terminal include a wired USB connection and/or a wireless BLUETOOTH® connection, wherein the wireless BLUETOOTH® connection comprises a connection using a HID protocol and/or a connection using an SPP protocol.

When the data transmitting module 130 and the intelligent terminal are in a wired USB connection, the control module 120 controls the data transmitting module 130 to transmit data in the wired USB connection mode; and when the data transmitting module 130 and the intelligent terminal are in a wireless BLUETOOTH® connection, the control module 120 controls the data transmitting module 130 to transmit the interaction data in the HID protocol if the interaction data is of single data bit, and the control module 120 controls the data transmitting module 130 to transmit the interaction data in the SPP protocol if the interaction data is of multiple data bits.

The above three connection modes may be used independently or in combination without conflicting with each other. The advantage is that the most quick and stable connection mode, i.e., the wired USB connection can be selected, or the user can use a more flexible connection mode, i.e., the wireless BLUETOOTH® connection. Meanwhile, it is adaptive to a control (HID protocol portion) universally used in the cellular phone system, and can also realize the unique function of the HMD.

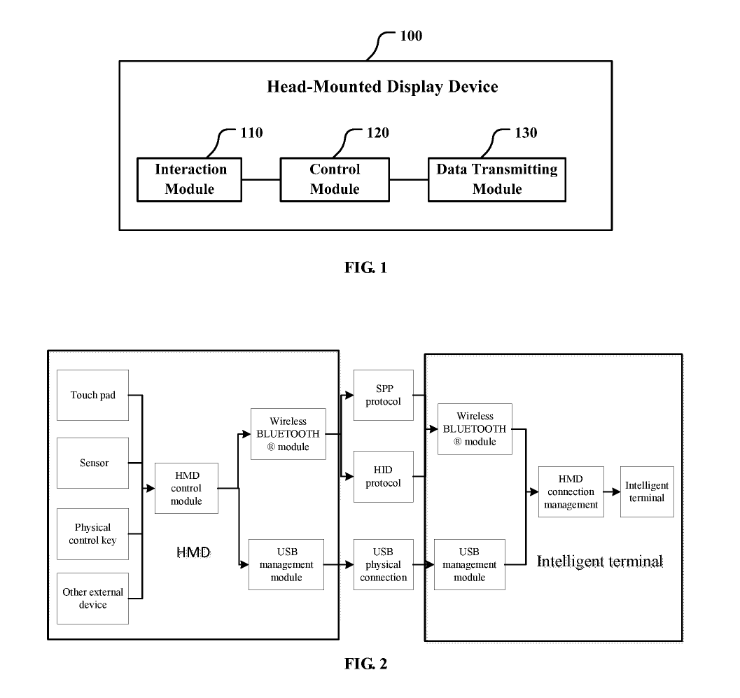

FIG. 2 is a schematic diagram illustrating a a method for interaction between a head-mounted display device and an intelligent terminal according to a non-limiting embodiment of the present invention, wherein the data transmitting module is specifically a wireless BLUETOOTH® module and a USB management module, as illustrated in FIG. 2:

connecting the intelligent terminal through a wireless BLUETOOTH®, and encapsulating data through an HID protocol to achieve a control management of the intelligent terminal by the HMD. After the wireless BLUETOOTH® is connected to the intelligent terminal, corresponding action is found for an encapsulation according to the HID protocol and different data given by the HMD control module. As to the standard action not defined in the HID (e.g., an action of the sensor), some actions in the HID protocol are self-defined and HID-transmitted to the intelligent terminal through the wireless BLUETOOTH®. The standard action of the HID can be directly processed by the intelligent terminal through protocol specifications of the HID. The self-defined data portion is parsed by the HMD connection management module on the intelligent terminal, converted into real HMD device actions and transmitted to the required module.

By connecting the wireless BLUETOOTH® with the intelligent terminal, and encapsulating data according to an SPP protocol, a control management of the intelligent terminal by the HMD, a data feedback from the intelligent terminal to the HMD, and other data interaction can be achieved. After the wireless BLUETOOTH® is connected to the intelligent terminal, different data given by the HMD control module and the different data are encapsulated in the SPP protocol format. Through an SPP data connection established between the wireless BLUETOOTH® and the intelligent terminal, an SPP can realize a bidirectional information interaction between the HMD device and the intelligent terminal. The HMD connection management module at the intelligent terminal parses the obtained SPP data, processes the data in real time to convert the data into real HMD device actions, and transfer the actions to the required module.

A connection with the intelligent terminal is made through a USB, a control management of the intelligent terminal is carried out through a USB-HID protocol, and information interaction, data transmission, etc. are performed between the intelligent terminal and the HMD by transmitting other data through the USB. After a connection is established between the HMD and the intelligent terminal through the USB, different data are given by the HMD control module, wherein data meeting the HID standard action is encapsulated in the HID protocol format and transferred to the intelligent terminal, and other data is transmitted to and interacted with the intelligent terminal in a self-defined protocol format. The USB data received by the intelligent terminal is parsed by the HMD connection management module on the intelligent terminal, so as to be converted into real HMD device actions, and transferred to the required module.

The control module on the head-mounted display device monitors the connection modes between the data transmitting module and the intelligent terminal in real time, and according to the processed interaction data, controls the data transmitting module to transmit the interaction data using one of the connection modes. Thus the communication mode is flexibly selectable, the interaction effect is better, and the user experience is improved.

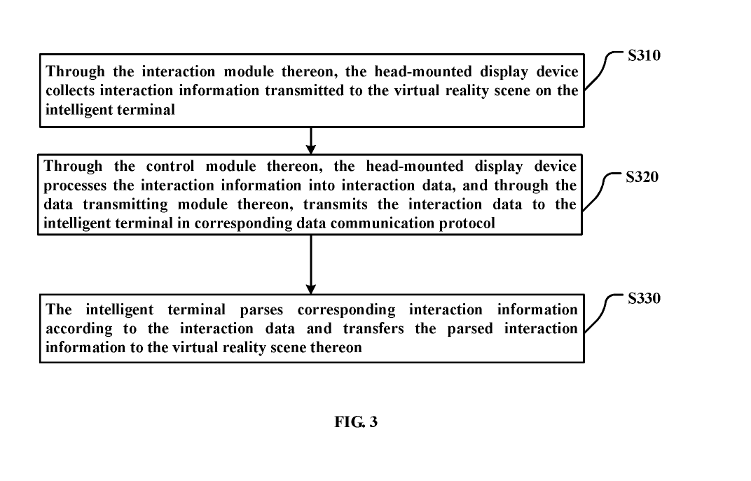

FIG. 3 is a flow diagram illustrating a non-limiting embodiment of a method for interaction between a head-mounted display device and an intelligent terminal according to an embodiment of the present invention, wherein the head-mounted display device is provided with an interaction module, a control module and a data transmitting module; the head-mounted display device establishes a communication connection with the intelligent terminal through the data transmitting module, and the intelligent terminal is installed with an application program which constructs a virtual reality scene.

As illustrated in FIG. 3, the method for interaction between the head-mounted display device and the intelligent terminal comprises:

Step S310: through the interaction module thereon, the head-mounted display device collects interaction information transmitted to the virtual reality scene on the intelligent terminal;

step S320: through the control module thereon, the head-mounted display device processes the interaction information into interaction data, and through the data transmitting module thereon, transmits the interaction data to the intelligent terminal in corresponding data communication protocol; and

step S330: the intelligent terminal parses corresponding interaction information according to the interaction data and transfers the parsed interaction information to the virtual reality scene thereon.

In one embodiment of the present invention, the interaction module includes one or more devices selected from a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor.

In one embodiment of the present invention, the interaction information comprises defined interaction information and undefined interaction information. The defined interaction information is processed into interaction data by the head-mounted display device through the control module according to a standard protocol format. The undefined interaction information is processed into interaction data of a uniform rule by the head-mounted display device through the control module according to a self-defined protocol format.

In one embodiment of the present invention, the head-mounted display device establishes one or more connection modes with the intelligent terminal through the data transmitting module, monitors the connection modes between the data transmitting module and the intelligent terminal in real time through the control module, and according to the processed interaction data, controls the data transmitting module to transmit the interaction data using one of the connection modes.

In one embodiment of the present invention, the connection modes with the intelligent terminal established by the head-mounted display device through the data transmitting module include a wired USB connection and/or a wireless BLUETOOTH® connection, wherein the wireless BLUETOOTH® connection comprises a connection using a HID protocol and/or a connection using an SPP protocol.

When the head-mounted display device is in a wired USB connection with the intelligent terminal through the data transmitting module, the head-mounted display device controls the data transmitting module through the control module to transmit data in the wired USB connection mode.

When the head-mounted display device is in a wireless BLUETOOTH® connection with the intelligent terminal through the data transmitting module, the head-mounted display device controls the data transmitting module through the control module to transmit the interaction datain the HID protocol if the interaction data is of single data bit, and controls the data transmitting module through the control module to transmit the interaction data in the SPP protocol if the interaction data is of multiple data bits.

To be noted, the embodiments of the method as illustrated in FIG. 3 are corresponding to those of the head-mounted display device as illustrated in FIG. 1, which have been described in details and herein are omitted.

In conclusion, the technical solution provided by the present invention by means of adding an interaction module on the head-mounted display device, collects interaction information to be input from the user to the virtual reality scene, processes the interaction information, and transmits processing result to the intelligent terminal in corresponding protocol for being processed by a virtual reality scene application program of the intelligent terminal, thereby achieving the purpose of interacting with the virtual reality scene through the head-mounted display device without any third party device, and improving the portability. As to undefined interaction information, it is processed into interaction data of a uniform rule by a control module on the head-mounted display device according to a self-defined protocol format. Multiple interaction devices are mounted on the head-mounted display device, and interaction information thereof is transferred to the intelligent terminal through the head-mounted display device. The intelligent terminal is only connected to one device, i.e., the head-mounted display device, thereby decreasing the load of the intelligent terminal, and improving the universality of the head-mounted display device, so that the head-mounted display device can be easily extended. The control module on the head-mounted display device monitors the connection modes between the data transmitting module and the intelligent terminal in real time, and according to the processed interaction data, controls the data transmitting module to transmit the interaction data using one of the connection modes. Thus the communication mode is flexibly selectable, the interaction effect is better, and the user experience is improved.

The above descriptions are just preferred embodiments of the present invention, rather than restrictions to the protection scope of the present invention. Any amendment, equivalent replacement, improvement, etc. made within the spirit and principle of the present invention shall fall within the protection scope of the present invention.

What is claimed is:

1. A head-mounted display device comprising:
an interaction module;
a control module; and
a data transmitting module,
wherein the control module is connected to the interaction module and the data transmitting module, respectively,
wherein the head-mounted display device is configured to establish a communication connection with an intelligent terminal through the data transmitting module, and the intelligent terminal is installed with an application program which constructs a virtual reality scene,
wherein the interaction module is configured to collect interaction information transmitted to the virtual reality scene on the intelligent terminal, and transmit the collected interaction information to the control module,
wherein the control module is configured to, after receiving the interaction information collected by the interaction module, process the interaction information into interaction data and transmit the interaction data to the data transmitting module, and
wherein the data transmitting module is configured to, after receiving the interaction data transmitted from the control module, transmit the interaction data to the intelligent terminal in corresponding data communication protocol, and the intelligent terminal parses corresponding interaction information according to the interaction data and transfers the parsed interaction information to the virtual reality scene thereon.

2. The head-mounted display device according to claim 1, wherein the interaction information collected by the interaction module comprises defined interaction information and undefined interaction information;
the defined interaction information is processed into interaction data by the control module according to a standard protocol format; and the undefined interaction information is processed into interaction data of a uniform rule by the control module according to a self-defined protocol format.

3. The head-mounted display device according to claim 1, wherein one or more connection modes are established between the data transmitting module and the intelligent terminal;
the control module monitors the connection modes between the data transmitting module and the intelligent terminal in real time, and according to the processed interaction data, controls the data transmitting module to transmit the interaction data using one of the connection modes.

4. The head-mounted display device according to claim 3, wherein the connection modes established between the data transmitting module and the intelligent terminal include a wired USB connection and/or a wireless BLUETOOTH® connection, wherein the wireless BLUETOOTH® connection comprises a connection using a HID protocol and/or a connection using an SPP protocol;
when the data transmitting module and the intelligent terminal are in a wired USB connection, the control module controls the data transmitting module to transmit data in the wired USB connection mode; and
when the data transmitting module and the intelligent terminal are in a wireless BLUETOOTH® connection, the control module controls the data transmitting module to transmit the interaction data in the HID protocol if the interaction data is of single data bit, and the control module controls the data transmitting module to transmit the interaction data in the SPP protocol if the interaction data is of multiple data bits.

5. The head-mounted display device according to claim 4, wherein the interaction module comprises one or more devices selected from a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor.

6. A method for interaction between a head-mounted display device and an intelligent terminal, wherein the head-mounted display device is provided with an interaction module, a control module and a data transmitting module, wherein the head-mounted display device establishes a communication connection with the intelligent terminal through the data transmitting module, and wherein the intelligent terminal is installed with an application program which constructs a virtual reality scene, the method comprising:
collecting, by the head-mounted display device through the interaction module thereon, interaction information transmitted to the virtual reality scene on the intelligent terminal;
processing, by the head-mounted display device through the control module thereon, the interaction information into interaction data, and through the data transmitting module thereon, transmitting the interaction data to the intelligent terminal in corresponding data communication protocol; and
parsing, by the intelligent terminal, corresponding interaction information according to the interaction data and transferring the parsed interaction information to the virtual reality scene thereon.

7. The method for interaction according to claim 6, wherein the interaction information collected by the interaction module comprises defined interaction information and undefined interaction information;
the defined interaction information is processed into interaction data by the head-mounted display device through the control module thereon according to a standard protocol format; and the undefined interaction information is processed into interaction data of a uniform rule by the head-mounted display device through the control module thereon according to a self-defined protocol format.

8. The method for interaction according to claim 6, wherein the head-mounted display device establishes one or more connection modes with the intelligent terminal through the data transmitting module thereon;
the head-mounted display device monitors the connection modes between the data transmitting module thereon and the intelligent terminal in real time through the control module thereon, and according to the processed interaction data, controls the data transmitting module thereon to transmit the interaction data using one of the connection modes.

9. The method for interaction according to claim 8, wherein the connection modes with the intelligent terminal established by the head-mounted display device through the data transmitting module thereon include a wired USB connection and/or a wireless BLUETOOTH® connection, wherein the wireless BLUETOOTH® connection comprises a connection using a HID protocol and/or a connection using an SPP protocol;
when the head-mounted display device is in a wired USB connection with the intelligent terminal through the data transmitting module thereon, the head-mounted display device controls the data transmitting module thereon through the control module thereon to transmit data in the wired USB connection mode;
when the head-mounted display device is in a wireless BLUETOOTH® connection with the intelligent terminal through the data transmitting module, the head-mounted display device controls the data transmitting module thereon through the control module thereon to transmit the interaction data in the HID protocol if the interaction data is of single data bit, and controls the data transmitting module thereon through the control module thereon to transmit the interaction data in the SPP protocol if the interaction data is of multiple data bits.

10. The method for interaction according to claim 9, wherein the interaction module comprises one or more devices selected from a touch pad, a physical key, a range sensor, a gyroscope, a light sensor, an acceleration sensor, a microphone, a magnetic sensor, a direction sensor, a pressure sensor, a temperature sensor, a humidity sensor, an inclination sensor, and a rotation vector sensor.
